(19) United States
(12) Patent Application Publication
(10) Pub. No.: US 2012/0167694 A1
(43) Pub. Date: Jul. 5, 2012

(54) PHOTOACOUSTIC IMAGING SYSTEM, CODED LASER EMITTING APPARATUS AND PHOTOACOUSTIC SIGNAL RECEIVING APPARATUS

(76) Inventor: Pai-Chi LI, Taipei (TW)

(21) Appl. No.: 13/098,611

(22) Filed: May 2, 2011

(30) Foreign Application Priority Data
Dec. 31, 2010 (TW) 099147334

(51) Int. Cl. G01H 9/00; H04B 10/04

(52) U.S. Cl. 73/657; 398/187; 398/190

(57) ABSTRACT

A photoacoustic imaging system comprising a coded laser emitting apparatus and a photoacoustic signal receiving apparatus is provided. The coded laser emitting apparatus comprises an encoding unit, a signal generating unit and a laser light source. The encoding unit is used for generating a coded signal. The signal generating unit is used for generating a modulated signal according to the coded signal. The laser light source is used for generating a laser pulse having a specific coded waveform according to the modulated signal. The photoacoustic signal receiving apparatus comprises a photoacoustic signal receiving unit and a decoding unit. The photoacoustic signal receiving unit is used for receiving a photoacoustic signal generated by an object having received the laser pulse and converts the photoacoustic signal into an electrical signal. The decoding unit is used for performing a decoding operation on the aforementioned electrical signal to generate a decoding result, so that a back-end circuit can construct a photoacoustic image according to the decoding result.

### FIELD OF THE INVENTION

The present invention generally relates to technologies in photoacoustic technology field, and more particularly to a photoacoustic imaging system, and to a coded laser emitting apparatus and a photoacoustic signal receiving apparatus of the photoacoustic imaging system.

### BACKGROUND OF THE INVENTION

Potoacoustic technologies are classified into two types according to the laser source thereof. One type is solid laser, a common technology of which is implemented for generating a photoacoustic signal through a Q-switched Nd:YAG laser. The other type is implemented for generating a photoacoustic signal through semiconductor laser. However, both the technologies of aforementioned two types have defect. A laser pulse power of the Q-switched Nd:YAG laser can generate a photoacoustic signal, but the defect of the manner is that an imaging rate of a photoacoustic image is limited by the pulse repetition frequency of the Q-switched Nd:YAG laser. The pulse repetition frequency of the semiconductor laser is far larger than the pulse repetition frequency of the Q-switched Nd:YAG laser, thus, the imaging rate of a photoacoustic image of the semiconductor laser is effectively improved. However, the laser pulse power of the semiconductor laser is far lower than the laser pulse power of the Q-switched Nd:YAG laser, thus, the signal intensity of the semiconductor laser is not good enough, thus, the quality of the photoacoustic image is decreased.

For improving the intensity of the photoacoustic signal generated by the semiconductor laser, there is a document discloses that the laser emitting power is strengthened by connecting several semiconductor laser light sources in parallel as shown in FIG. 1. FIG. 1 shows a conventional semiconductor laser emitting apparatus. Referring to FIG. 1, the semiconductor laser emitting apparatus includes a pulse generator 102, a plurality of laser drivers 104, a plurality of semiconductor laser light sources 106 having same laser light wave length, and a plurality of optical fibers 108. The plurality of laser drivers 104 are synchronously triggered by the pulse generator 102, and further drive corresponding semiconductor laser light sources 106, so that the plurality of semiconductor laser light source 106 can generate laser lights with a same phase. The laser lights generated by the plurality of semiconductor laser light sources 106 can be combined into a new laser light beam by the plurality of optical fibers 108 to form a laser output with a total power.

However, the semiconductor laser emitting apparatus shown in FIG. 1 has some defect. For example, if one more semiconductor laser light source 106 is added, one more laser driver 104 and one more optical fiber 108 must be correspondingly added. However, when the semiconductor laser emitting apparatus drives the plurality of semiconductor laser light sources 106, a reaction delay of any of the laser drivers 104 must be avoided, so that the laser output can be ensured to have a largest total power. In addition, the laser light beam formed by the optical fibers 108 needs to have a focusing adjustment. Thus, though the semiconductor laser emitting apparatus can improve the laser output power thereof, however, the system cost and complexity are also increased.

### SUMMARY OF THE INVENTION

The invention is directed to provide a coded laser emitting apparatus, wherein a photoacoustic imaging system using the coded laser emitting apparatus can generate a photoacoustic signal with enough intensity, and has relatively low cost and low system complexity.

The invention is also directed to provide a photoacoustic signal receiving apparatus, which is used cooperating with above-mentioned coded laser emitting apparatus.

The invention is further directed to provide a photoacoustic imaging system, which adopts the above-mentioned coded laser emitting apparatus and the above-mentioned photoacoustic signal receiving apparatus is provided.

In one aspect, the coded laser emitting apparatus includes an encoding unit, a signal generating unit and a laser light source. The encoding unit is used for generating a coded signal. The signal generating unit is used for generating a modulated signal according to the coded signal. The laser light source is used for generating a laser pulse having a specific coded waveform according to the modulated signal.

In another aspect, the photoacoustic signal receiving apparatus includes a photoacoustic signal receiving unit and a decoding unit. The photoacoustic signal receiving unit is used for receiving a photoacoustic signal generated by an object having received the laser pulse and converts the photoacoustic signal into an electrical signal. The decoding unit is used for performing a decoding operation on the aforementioned electrical signal to generate a decoding result, so that a back-end circuit can construct a photoacoustic image according to the decoding result.

In a third aspect, the photoacoustic imaging system includes a coded laser emitting apparatus and a photoacoustic signal receiving apparatus.

In an embodiment of the present invention, the signal generating unit generates the modulated signal through at least one of analog modulation and digital modulation, according to the coded signal.

In an embodiment of the present invention, the encoding unit generates the coded signal by at least one of a phase encoding manner and a frequency encoding manner.

In an embodiment of the present invention, the phase coding is a Golay code encoding manner or a Barker code encoding manner.

In an embodiment of the present invention, the frequency encoding manner includes a Chirp code encoding manner.

In an embodiment of the present invention, a code length of the laser pulse has a predetermined time span, an object received the laser pulse generates a photoacoustic signal, and the coded laser emitting apparatus emits a next laser pulse after the photoacoustic signal being completely received.

In an embodiment of the present invention, the laser light source is a semiconductor laser light source.

In an embodiment of the present invention, the photoacoustic imaging system further comprises a signal amplifying unit electronically connected between the photoacoustic signal receiving unit and the decoding unit, the signal amplifying unit is used for amplifying the electrical signal.

In an embodiment of the present invention, the photoacoustic signal receiving unit includes at least one photoacoustic signal receiving probe.

In the present invention, the laser emitting apparatus is capable of generating a laser pulse having a specific coded waveform, thus, after an object receives the laser pulse, the object can correspondingly generate a photoacoustic signal having the specific coded waveform, wherein the photoacoustic signal can be a coded photoacoustic signal. Because a total power and a code length of the laser pulse having a specific coded waveform have a positive correlation, the total power of the generated photoacoustic signal can be increased according to increase of the code length of the laser pulse. In other words, a stronger signal can be obtained by increasing the code length of the laser pulse. Thus, a photoacoustic image having good image quality can be further obtained, so long as the photoacoustic signal receiving apparatus performs a decoding operation on the photoacoustic signal.

Additionally, the photoacoustic signal receiving apparatus can converts the coded photoacoustic signal into an electrical signal having a same waveform information with the specific waveform, and then performs a decoding operation on the electrical signal, and the waveform and frequency of the decoded electrical signal are identical with the waveform and frequency of the electrical signal generated according to the original laser pulse without encoding. Therefore, the encoded laser can not only improve the intensity of the photoacoustic signal, and the decoded electrical signal can keep the axial resolution of the electrical signal generated according to the original laser pulse without encoding.

For above and another objectives, features, and advantages of the present invention being better understood and legibly, accompanying embodiments together with the drawings are particularized.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 shows a conventional semiconductor laser emitting apparatus;

FIG. 2 shows a photoacoustic imaging system in accordance with a preferred embodiment of the present invention;

FIG. 3 shows an embodiment of a digital modulation;

FIG. 4A shows an embodiment of a modulated signal;

FIG. 4B shows another embodiment of a modulated signal;

FIG. 4C shows a third embodiment of a modulated signal; and

FIG. 5 shows two neighboring coded laser pulses.

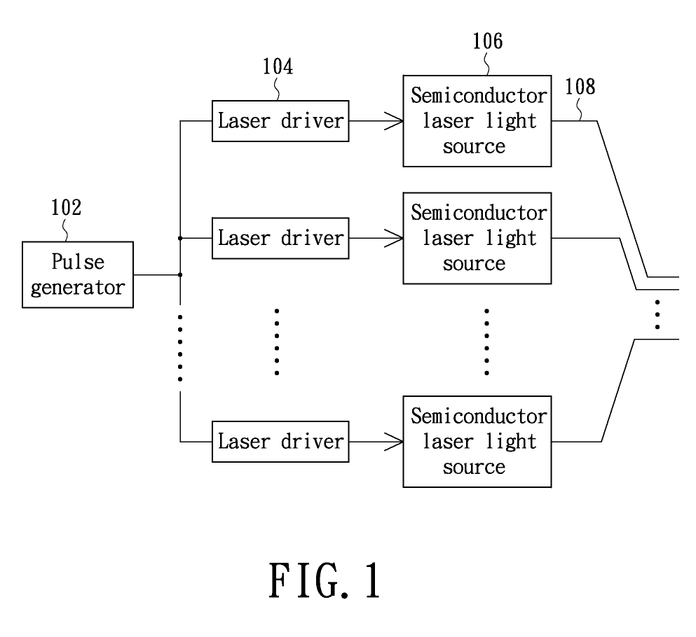

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

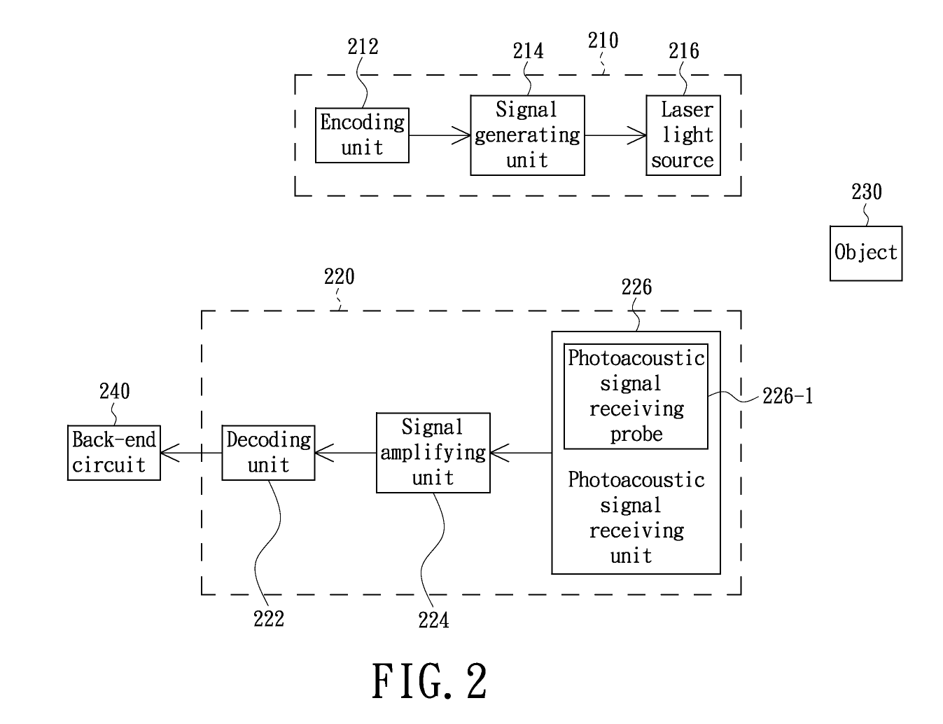

FIG. 2 shows a photoacoustic imaging system in accordance with a preferred embodiment of the present invention. Referring to FIG. 2, the photoacoustic imaging system includes a coded laser emitting apparatus 210 and a photoacoustic signal receiving apparatus 220. The coded laser emitting apparatus 210 includes an encoding unit 212, a signal generating unit 214 and a laser light source 216. The encoding unit 212 is used for generating a coded signal, and the signal generating unit 214 is used for generating a modulated signal according to the coded signal. The laser light source 216 is used for generating a laser pulse having a specific coded waveform according to the modulated signal. The laser light source can be a semiconductor laser light source.

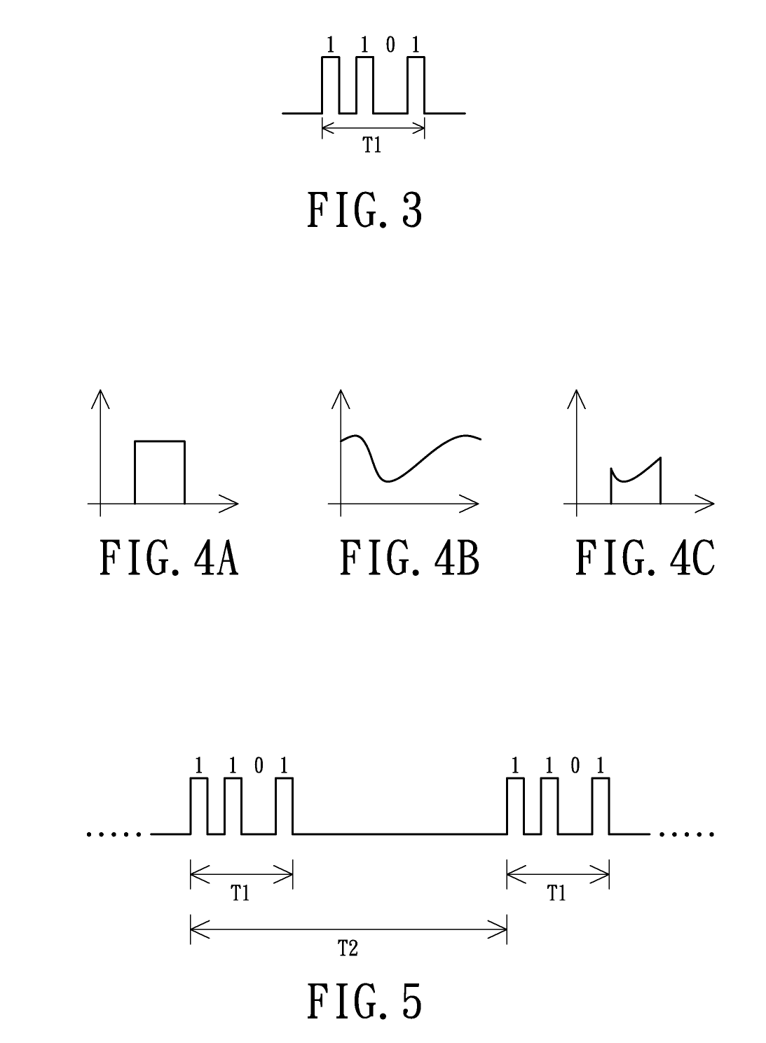

The signal generating unit 214 generates the modulated signal through at least one of analog modulation and digital modulation according to the coded signal output from the encoding unit 212. FIG. 3 shows an embodiment of the digital modulation. Referring to FIG. 3, the signal generating unit 214 can implement digital modulation according to the coded signal to generate a modulated signal having a code of 1101. A code length of the modulated signal has a predetermined time span T1. Referring to FIG. 2 again, the input and output of the laser light source 216 can be designed to have a linear relation, thus, if the signal generating unit 214 outputs a modulated signal with a waveform, the laser light source 216 can output a laser pulse with a same waveform. Further explanation is provided referring to FIG. 4A, FIG. 4B and FIG. 4C.

Please refer to FIG. 2, FIG. 4A, FIG. 4B and FIG. 4C in accordance with the following disclosure. When the signal generating unit 214 only implements a digital modulation and outputs a modulated signal as shown in FIG. 4A to the laser light source 216, the laser light source 216 outputs a laser pulse having a same waveform with the modulated signal as shown in FIG. 4A. When the signal generating unit 214 only implements an analog modulation and outputs a modulated signal as shown in FIG. 4B to the laser light source 216, the laser light source 216 outputs a laser pulse having a same waveform with the modulated signal as shown in FIG. 4B. When the signal generating unit 214 implements a digital and analog hybrid modulation, that is when the signal generating unit 214 implements a digital modulation and an analog modulation together and outputs a modulated signal as shown in FIG. 4C to the laser light source 216, the laser light source 216 outputs a laser pulse having a same waveform with the modulated signal as shown in FIG. 4C. Thus, the laser light source 216 can generate a laser pulse having a specific coded waveform according to the above-mentioned operation.

Of course, the encoding unit 212 can generates the coded signal by at least one of a phase encoding manner and a frequency encoding manner that are commonly used for ultrasound coding. The phase coding can be exemplarily a Golay code encoding manner or a Barker code encoding manner, and the frequency encoding manner can be exemplarily a Chirp code encoding manner.

Please refer to FIG. 2 again. When an object 230 receives the laser pulse having a specific coded waveform, the object 230 can correspondingly generate a photoacoustic signal having the specific coded waveform, wherein the photoacoustic signal can be regarded as a coded photoacoustic signal. Because a total power of the coded laser pulse as exemplarily shown in FIG. 3 is positive correlation with a code length of the coded laser pulse, thus, the total power of the generated photoacoustic signal is increased due to an increase of the code length of the laser pulse. In other words, a stronger signal can be obtained by increasing the code length of the laser pulse. Thus, a photoacoustic image having good image quality can be further obtained, so long as the photoacoustic signal receiving apparatus 220 performs a decoding operation on the photoacoustic signal. A further explanation of the photoacoustic signal receiving apparatus 220 is provided as follows.

The photoacoustic signal receiving apparatus 220 mainly includes a photoacoustic signal receiving unit 226 and a decoding unit 222. The photoacoustic signal receiving unit 226 is used for receiving a photoacoustic signal (that is a coded photoacoustic signal) generated by the object 230 having received the laser pulse having specific waveform, and converts the received photoacoustic signal into an electrical signal having a same waveform information with the specific waveform. The decoding unit 222 is used for performing a decoding operation on the aforementioned electrical signal to generate a decoding result, so that a back-end circuit 240 can construct a photoacoustic image according to the decoding result. Preferably, the photoacoustic signal receiving apparatus 220 further includes a signal amplifying unit 224, which is electronically connected between the photoacoustic signal receiving unit 226 and the decoding unit 222, so that the signal amplifying unit can be used for amplifying the electrical signal outputted from the photoacoustic signal receiving unit 226.

In the embodiment, the photoacoustic signal receiving apparatus 220 has the photoacoustic signal receiving unit 226 that can converts the photoacoustic signal having a specific waveform into an electrical signal having a same waveform information with the specific waveform, and the decoding unit 222 performs a decoding operation on the received electrical signal, and the waveform and frequency of the decoded electrical signal are identical with the waveform and frequency of the electrical signal generated according to the original laser pulse without encoding. Therefore, the encoded laser can improve the intensity of the photoacoustic signal, and the decoded electrical signal can keep the axial resolution of the electrical signal generated according to the original laser pulse without encoding.

In addition, in the present invention, the photoacoustic signal receiving unit 226 includes at least one photoacoustic signal receiving probe labeled as 226-1, the photoacoustic signal receiving probe is used for converting a photoacoustic signal to an electrical signal. It needs to be pointed out that, if the photoacoustic signal receiving unit 226 includes a plurality of photoacoustic signal receiving probes 226-1, the photoacoustic signal receiving probes 226-1 can be arranged in a one-dimensional array or a two-dimensional array.

Additionally, it must be concerned that, an interval between each two coded laser pulse generated by the coded laser emitting apparatus 210 has a limitation as explained in FIG. 5. FIG. 5 shows two neighboring coded laser pulses, wherein each of the coded laser pulses has a code of 1101. Referring to FIG. 5, a code length of each laser pulse has a predetermined time period T1, and a time difference of the starting times of the two laser pulses is T2. The time difference T2 can be properly designed, to ensure that the coded laser emitting apparatus 210 can emit a next laser pulse after the photoacoustic signal generated according to each coded laser pulse has been completely received by the photoacoustic signal receiving apparatus 220.

As stated above, in the present invention, the laser emitting apparatus can generate a laser pulse having a specific coded waveform, thus, after an object receives the laser pulse, the object can correspondingly generate a photoacoustic signal having the specific coded waveform, wherein the photoacoustic signal can be a coded photoacoustic signal. Because a total power and a code length of the laser pulse having a specific coded waveform have a positive correlation, thus, the total power of the generated photoacoustic signal can be increased due to an increase of the code length of the laser pulse. In other words, a stronger signal can be obtained by increasing the code length of the laser pulse. Thus, a photoacoustic image having good image quality can be further obtained, so long as the photoacoustic signal receiving apparatus performs a decoding operation on the photoacoustic signal.

Additionally, the photoacoustic signal receiving apparatus can converts the coded photoacoustic signal into an electrical signal having a same waveform information with the specific waveform, and then performs a decoding operation on the electrical signal, and the waveform and frequency of the decoded electrical signal are identical with the waveform and frequency of the electrical signal generated according to the original laser pulse without encoding. Therefore, the encoded laser can improve the intensity of the photoacoustic signal, and the decoded electrical signal can keep the axial resolution of the electrical signal generated according to the original laser pulse without encoding.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A coded laser emitting apparatus, comprising:
an encoding unit used for generating a coded signal;
a signal generating unit used for generating a modulated signal according to the coded signal; and
a laser light source used for generating a laser pulse having a specific coded waveform according to the modulated signal.

2. The coded laser emitting apparatus as claimed in claim 1, wherein the signal generating unit generates the modulated signal through at least one of analog modulation and digital modulation according to the coded signal.

3. The coded laser emitting apparatus as claimed in claim 1, wherein the encoding unit generates the coded signal by at least one of a phase encoding manner and a frequency encoding manner.

4. The coded laser emitting apparatus as claimed in claim 3, wherein the phase coding is a Golay code encoding manner or a Barker code encoding manner.

5. The coded laser emitting apparatus as claimed in claim 3, wherein the frequency encoding manner includes a Chirp code encoding manner.

6. The coded laser emitting apparatus as claimed in claim 1, wherein a code length of the laser pulse has a predetermined time span, an object received the laser pulse generates a photoacoustic signal, and the coded laser emitting apparatus emits a next laser pulse after the photoacoustic signal being completely received.

7. The coded laser emitting apparatus as claimed in claim 1, wherein the laser light source is a semiconductor laser light source.

8. A photoacoustic signal receiving apparatus, comprising:
a photoacoustic signal receiving unit used for receiving a photoacoustic signal generated by an object having received the laser pulse and converting the photoacoustic signal into an electrical signal; and
a decoding unit used for performing a decoding operation on the aforementioned electrical signal to generate a decoding result, so that a back-end circuit can construct a photoacoustic image according to the decoding result.

9. The photoacoustic signal receiving apparatus as claimed in claim 8, further comprising:
a signal amplifying unit, electronically connected between the photoacoustic signal receiving unit and the decoding unit, the signal amplifying unit being used for amplifying the electrical signal.

10. The photoacoustic signal receiving apparatus as claimed in claim 8, wherein the photoacoustic signal receiving unit includes at least one photoacoustic signal receiving probe.

11. A photoacoustic imaging system, comprising:
a coded laser emitting apparatus, comprising:
an encoding unit used for generating a coded signal;
a signal generating unit used for generating a modulated signal according to the coded signal; and
a laser light source used for generating a laser pulse having a specific coded waveform according to the modulated signal; and
a photoacoustic signal receiving apparatus, comprising:
a photoacoustic signal receiving unit used for receiving a photoacoustic signal generated by an object having received the laser pulse and converting the photoacoustic signal into an electrical signal; and
a decoding unit used for performing a decoding operation on the aforementioned electrical signal to generate a decoding result, so that a back-end circuit can construct a photoacoustic image according to the decoding result.

12. The photoacoustic imaging system as claimed in claim 11, wherein the signal generating unit generates the modulated signal through at least one of analog modulation and digital modulation according to the coded signal.

13. The photoacoustic imaging system as claimed in claim 11, wherein the encoding unit generates the coded signal by at least one of a phase encoding manner and a frequency encoding manner.

14. The photoacoustic imaging system as claimed in claim 13, wherein the phase coding is a Golay code encoding manner or a Barker code encoding manner.

15. The photoacoustic imaging system as claimed in claim 13, wherein the frequency encoding manner includes a Chirp code encoding manner.

16. The photoacoustic imaging system as claimed in claim 11, wherein a code length of the laser pulse has a predetermined time span, an object received the laser pulse generates a photoacoustic signal, and the coded laser emitting apparatus emits a next laser pulse after the photoacoustic signal being completely received.

17. The photoacoustic imaging system as claimed in claim 11, wherein the laser light source is a semiconductor laser light source.

18. The photoacoustic imaging system as claimed in claim 11, further comprising:
a signal amplifying unit, electronically connected between the photoacoustic signal receiving unit and the decoding unit, the signal amplifying unit being used for amplifying the electrical signal.

19. The photoacoustic imaging system as claimed in claim 11, wherein the photoacoustic signal receiving unit includes at least one photoacoustic signal receiving probe.
